(19) United States
(12) Patent Application Publication
(10) Pub. No.: US 2017/0089515 A1
(43) Pub. Date: Mar. 30, 2017

(54) SAFETY DECK CLAMP FOR GARDEN TORCHES AND OTHER ITEMS

(71) Applicants: Michael E. Snyder, Pittsburgh, PA (US); David J. Augustyniak, Kingsville, MD (US)

(72) Inventors: Michael E. Snyder, Pittsburgh, PA (US); David J. Augustyniak, Kingsville, MD (US)

(21) Appl. No.: 15/275,864

(22) Filed: Sep. 26, 2016

Related U.S. Application Data
(60) Provisional application No. 62/232,811, filed on Sep. 25, 2015.

(51) Int. Cl. F16M 13/02; E04H 12/22; F16B 2/22

(52) U.S. Cl. CPC F16M 13/022; F16B 2/22; E04H 12/22

(57) ABSTRACT

A safety deck clamp for removably attaching and supporting the pole of deck torch or other item to a vertical deck rail. The safety clamp may be molded as a unitary part and formed with a three-sided yoke at one end substantially in a U-shape with a pair of resilient arms, the yoke being joined to an annular collar by a neck. The arms extend to a pair of detent prongs shaped as inwardly-facing right triangles that slightly overhang the arms. The resiliency of the arms works with the overhanging triangles to releasably lock the deck clamp onto the vertical deck rail. A circular collar supported by the neck has a closed or open circular recess for insertion of the torch pole. In addition, a shoulder is offset beneath the arms of the yoke for biting and supporting the clamp against the vertical deck rail.

### CROSS-REFERENCE TO RELATED APPLICATION

This application derives priority from U.S. Provisional Patent Application Ser. No. 62/232,811 filed 25 Sep. 2015.

### BACKGROUND OF THE INVENTION

1. Field of the Invention

The present invention relates to clamps and, more particularly, to an improved safety clamp for mounting garden torches, e.g., “Tiki” torches to the vertical rails of most common decks, as well as other deck items.

2. Description of the Background

Garden torches (or “Tiki” torches) are extremely popular for nighttime illumination of decks and gardens, and indeed trace their origins to early inhabitants of the South Pacific Islands. Today Tiki torches not only provide a source of light but also enhance the landscape of a home, building, hotel, or the like. There are many different types of torches in use today, manufactured of wood or metal. Most burn a canister of oil, but others are fueled from underground gas pipes. Of the former, the head of the torch typically is that canister of oil rigidly attached to the top of a pole. A wick protrudes from the canister, and the canister/wick is relatively heavy and typically elevated several feet above the deck on a pole. These poles are often speared into the ground, inserted into a bucket full of sand or soil to hold the torch upright, or attached to the deck by a bracket. Various forms of brackets have been used for securing the pole to deck rails, including removable screw-clamps, or permanent screws or other hardware to secure the bracket to the deck rail. Once mounted, the permanent brackets are fixed and not movable as needed.

The top-heavy configuration of Tiki torches presents a number of inherent safety issues including a risk of spilling a volatile and combustible fuel which can create a fire hazard. The removable screw-clamp approach taken by most manufacturers does not provide stability. This is especially true on wood decks where the wood can contract or rot, loosening the clamp.

Therefore, a primary objective of the present invention is the provision of an improved bracket assembly for removably mounting a Tiki pole to a deck rail in a highly stable manner. One skilled in the art will understand that the same basic bracket assembly may also be used to mount other items including cup holders, banner clips, flag pole holders, flower pot holders.

### SUMMARY OF THE INVENTION

It is, therefore, an object of the present innovation to provide an improved bracket assembly for removably mounting a Tiki pole to a vertical deck rail in a safe and stable manner.

It is another object to provide an improved bracket assembly as above that securely grips the vertical deck rail.

It is another object to provide a bracket assembly suitable for mounting a variety of other items to decks including cup holders, banner clips, flag pole holders, flower pot holders.

It is another object to provide an improved bracket assembly as above that is easily manufactured, aesthetically pleasing, economical to produce, rugged, and reliable.

The foregoing and other objects are provided by a safety deck clamp for removably attaching and supporting the pole of deck torch (or other pole-shaped or other objects) to a vertical deck rail. The safety clamp may be molded as a unitary part and formed substantially in a U-shape with a pair of resilient arms joined by a neck. The arms extend to a pair of detent prongs shaped as inwardly-facing right triangles that slightly overhang the arms. The resiliency of the arms combined with the overhanging triangular detent prongs serves to releasably lock the deck clamp onto a vertical deck rail when pushed into place. A circular collar is supported by the neck, and is formed with a circular recess for insertion of the torch pole. In addition, a foot is offset beneath the arms for biting and supporting the clamp against the vertical deck rail once clamped in place. When used for supporting a top-heavy deck torch a pair of safety deck clamps are used, one at the base and one located medially. The base deck clamp is formed with a closed-bottom circular recess for seating the torch pole, while the medial deck clamp is formed with a pass-through circular recess for passing the torch pole.

Other objects, features, and advantages of the present invention will become more apparent from the following detailed description of the preferred embodiments and certain modifications thereof.

### BRIEF DESCRIPTION OF THE DRAWINGS

FIG. 1 is a perspective view of a pair of safety deck clamps 2 being used for supporting a top-heavy deck torch according to the invention.

FIG. 2 is a close-up perspective view of the safety deck clamp 2 of FIG. 1.

FIG. 3 is a side view of a pair of safety deck clamps 2 as in FIG. 1.

FIG. 4 is a side view of the safety deck clamp 2 of FIGS. 1-3.

FIG. 5 is a front view of the safety deck clamp 2 of FIGS. 1-4.

FIG. 6 is a top view of the safety deck clamp 2 of FIGS. 1-5.

### DETAILED DESCRIPTION OF THE PREFERRED EMBODIMENT

As seen in FIG. 1, the present invention is an improved safety deck clamp 2 for garden torches that removably mounts the torch by its pole to vertical deck rail having a uniform polygonal cross-section in a stable yet aesthetically pleasing manner. When used for supporting a top-heavy deck torch as shown, a pair of safety deck clamps 2 are preferably used, one at the base of the torch pole and one located medially as illustrated. The safety deck clamp 2 is best-suited for deck rails having a constant square or rectangular cross-section, though one skilled in the art will understand that the deck clamp 2 can be modified for trapezoidal or other cross-sections.

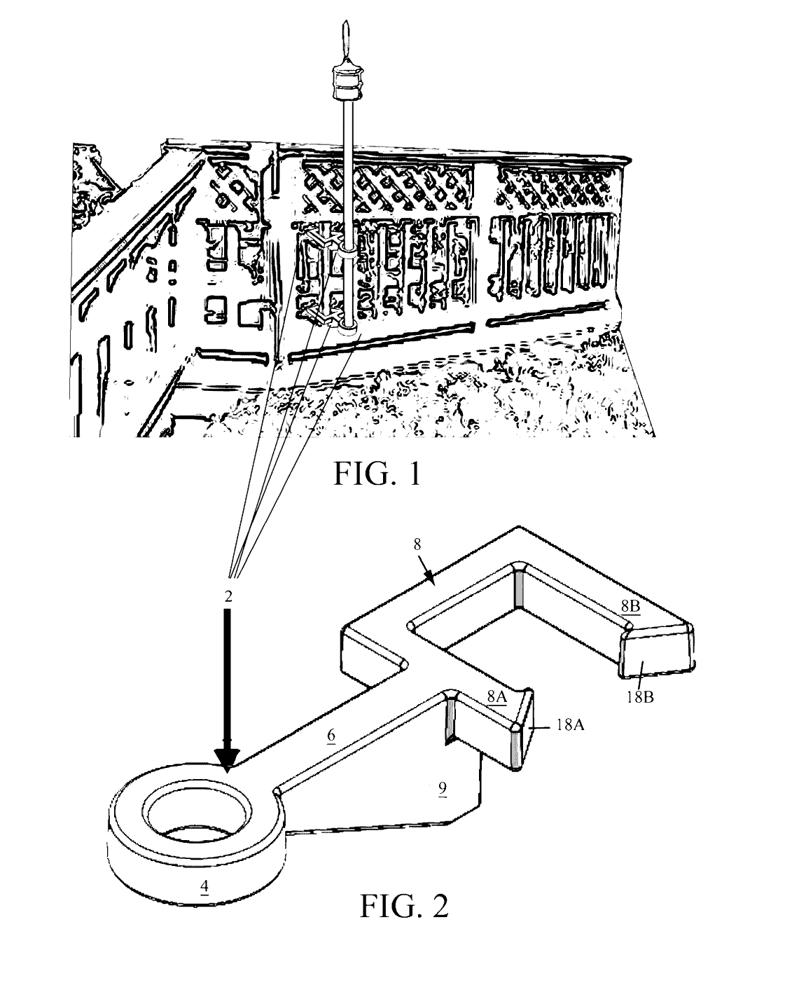

As seen in FIG. 2, the safety deck clamp 2 generally comprises a hanging mount with a resilient clamping-yoke 8 having a pair of arms 8a, 8b that embrace the vertical deck rail, and which support a collar 4 forwardly of the deck rail. The collar 4 is preferably an annular member formed with a 1″-2″ central circular recess for insertion of the Tiki torch pole. A neck 6 joins the collar 4 to one of the two arms 8a, suspending the other parallel arm 8B a small distance from the first arm 8A configured to be marginally larger than the thickness of the deck rail to which clamp 2 will be attached. The neck 6 spaces the collar 4 from the yoke 8 by a distance preferably within a range of from 2 to 3 inches, and most preferably by about 2.5″ as shown below in FIGS. 4-6. The neck 6 is somewhat triangular, expanding downward from the collar 4 to a weight-bearing shoulder 9. The shoulder 9 has a flat weight-bearing surface co-planar with the interior surface of the arm 8A but extended downward therefrom to a right-angle edge that bites down into the deck rail to grip the rail and stabilize the clamp 2 against it. The arms 8a, 8b extend in parallel to a pair of inwardly-protruding detent prongs 18a, 18b at the distal tips. The arms 8a, 8b are slightly resilient, more so for the outer arm 8B, and indeed the entire deck clamp 2 may be integrally molded from resilient plastic such as polyvinyl chloride (PVC) or acrylonitrile butadiene styrene (ABS). Each detent prong 18a, 18b forms an inwardly-facing right triangle that slightly overhangs the arms 8a, 8b. The angled edge of detent prongs 18a, 18b eases and guides insertion, separating the arms 8a, 8b when pushed against the rail, until the overhang clears and the arms 8a, 8b resiliently clamp around and locks into place embracing the vertical deck rail. Most deck rails are 2″ thickness, and thus the preferred spacing for arms 8a, 8b is slightly more than 2″.

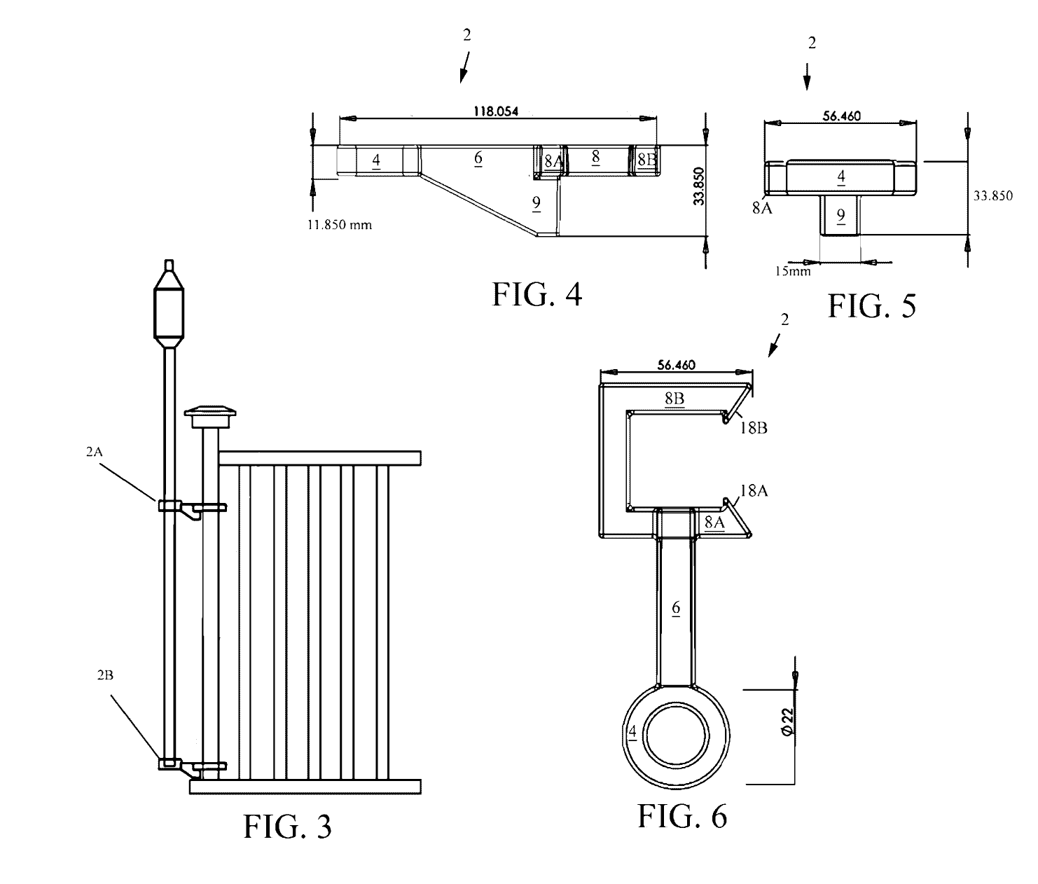

As shown in FIG. 3, when the safety deck clamps 2 are used for supporting a top-heavy deck torch as shown in a vertical orientation, a pair of clamps 2 are preferably used. For the lowermost deck clamp 2 at the base the circular recess of collar 4 is closed at the bottom to limit insertion of the Tiki torch pole, the depth of the recess being about 1-1.5″ to support the pole upright. For the medial deck clamp 2 the circular recess is a pass-through aperture for pass-through insertion of the Tiki torch pole. The lowermost deck clamp 2 at the base supports the full weight of the Tiki torch and the medial deck clamp 2 prevents tipping.

In addition, the neck 6 extends shoulder 9 down below the arms 8a, 8b so as to engage the deck rail with a lever action, thereby gripping the rail and stabilizing the clamp 2 and Tiki torch. The lever action results from the laterally-offset collar 4 of the lowermost deck clamp 2 which supports the full weight of the Tiki torch, and the outer arm 8B which serves as a fulcrum against the rear of the deck rail. Thus, the deck clamp 2 translates the downward gravitational force F of the Tiki torch into a torque about the fulcrum of the outer arm 8B, and since the force F is vertical, the torque is equal to the moment arm (distance between the collar 4 and outer arm 8B) times the force F. Thus, for a 2 pound torch the torque is roughly less than 1 Newton-Meter. This torque has a major vector component oriented directly down along the incline of the shoulder 9, which abuts the deck rail thereby equalizing the force. In addition, there is a slight vertical offset between detent prongs 18a, 18b and the lower edge of shoulder 9. The vertical offset between detent prongs 18a, 18b and shoulder 9 is preferably within a range of from 0.5-1.5 inches, and is most preferably 1.33″. When the detent prongs 18a, 18b embrace and grip the deck rail, the shoulder 9 pivots downward causing the upper inner edge of outer arm 8B and the lower edge of shoulder 9 to bite into the deck rail, thereby preventing the deck clamp 2 from slipping downward. The safety deck clamp 2 will not slip or ride down along the deck rail, but rather remains tightly fixed in position. The very slight forward tilt also directs the deck torch pole outward and away from the deck. The result is an improved safety deck clamp, and a combination of a base/medial pair thereof that together form a safety bracket assembly that easily mounts a Tiki pole to a vertical deck rail in safer and more stable manner. The resiliency of the arms 8a, 8b allows the clamp 2 to be easily removed and/or repositioned by removing the Tiki torch and manually separating the arms 8A, 8B. Moreover, the clamp 2 is aesthetically pleasing, eliminates safety hazards by its secure grip on the vertical deck rail, and is economical to manufacture and produce by conventional injection molding techniques.

FIGS. 4-6 are a side view, front view and top view of an exemplary embodiment of the safety deck clamp 2 of FIGS. 1-3 with preferred dimensions in millimeters.

Again, one skilled in the art should readily understand that the dimensions of FIGS. 4-6 may be scaled, and the basic safety deck clamp design can alternatively be used to mount other pole-shaped items such as cup holders, banner clips, flag pole holders, flower pot holders, and with minor modification to the collar 4 may be adapted for holding still other deck items as well.

Having now fully set forth the preferred embodiment, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A safety deck clamp for removably supporting an article by attachment to a vertical deck rail, comprising:
a monolithic plastic body formed with an annular collar at one end having a central circular recess, a three-sided polygonal yoke at another end including an extended pair of resilient arms that extend to counter-opposed detent prongs shaped as inwardly-facing right triangles at the distal tip of each of said arms, each said detent prong slightly overhanging the respective arm, and a neck connecting said collar to one of said arms at a fixed distance, said neck ramping downward from said collar to a shoulder protruding below said yoke for biting and supporting said clamp against said vertical deck rail.

2. The safety deck clamp according to claim 1, wherein said three-sided polygonal yoke is substantially square.

3. The safety deck clamp according to claim 2, wherein said pair of resilient arms includes an inner arm joined to said neck and a parallel outer arm.

4. The safety deck clamp according to claim 3, wherein said inner arm and said outer arm comprise flat-facing interior surfaces.

5. The safety deck clamp according to claim 4, wherein said shoulder comprises a flat weight-bearing surface coplanar with the interior surface of said inner arm.

6. The safety deck clamp according to claim 5, wherein said shoulder comprises a right-angle edge at the distal end of said weight-bearing surface.

7. The safety deck clamp according to claim 1, wherein said annular collar is formed with a circular recess within a range of from 1″-2″ for insertion of a pole.

8. The safety deck clamp according to claim 7, wherein said circular recess is closed-bottom.

9. The safety deck clamp according to claim 7, wherein said circular recess is pass-through.

10. The safety deck clamp according to claim 1, wherein said monolithic body is integrally molded from one of polyvinyl chloride (PVC) or acrylonitrile butadiene styrene (ABS).

11. The safety deck clamp according to claim 3, wherein said first arm is spaced from said second arm by approximately two inches.

12. The safety deck clamp according to claim 1, wherein said neck spaces said collar from said yoke by a distance within a range of from 2 to 3 inches.

13. The safety deck clamp according to claim 12, wherein said neck spaces said collar from said yoke by approximately 2.5 inches.

14. The safety deck clamp according to claim 3, wherein a gravitational force F imparted to said collar imposes a torque about said outer arm, which serves as a fulcrum against the rear of said deck rail.

15. The safety deck clamp according to claim 14, wherein said torque is equal to the gravitational force F times a length of said neck.

16. A safety deck clamp for removably supporting a torch by its pole on a vertical deck rail, comprising a monolithic plastic body formed with an annular collar at one end having a central circular recess, and a three-sided open yoke at another end including a first resilient arm and a parallel second resilient arm, said first arm extending to a detent prong at its distal tip shaped as inwardly-facing right triangle, said second arm extending to a counter-opposed detent prong at its distal tip shaped as inwardly-facing right triangle, each said detent prong slightly overhanging the respective first and second resilient arms, and a neck connecting said collar to said yoke at a fixed distance, said neck ramping downward from said collar below said yoke to a shoulder exposing a flat weight-bearing surface protruded beneath said yoke, said flat weight-bearing surface terminating at an edge offset from said yoke for biting and supporting said clamp against said vertical deck rail, wherein a gravitational force F imparted to said collar imposes a torque about said yoke which serves as a fulcrum against the rear of said deck rail.

17. The safety deck clamp according to claim 16, wherein said three-sided open yoke is substantially square.

18. The safety deck clamp according to claim 17, wherein said first arm and said second arm comprise flat-facing interior surfaces.

19. The safety deck clamp according to claim 18, wherein the flat weight-bearing surface of said shoulder is coplanar with the flat interior surface of said first arm.

20. A pair of safety deck clamps both according to claim 16, one of said pair of safety deck clamps having a collar with a closed-bottom circular recess, and the other of said pair of safety deck clamps having a collar with an open pass-through circular recess.
